(19) United States
(12) Patent Application Publication
(10) Pub. No.: US 2007/0096575 A1
(43) Pub. Date: May 3, 2007

(54) Flywheel magnet rotor

(75) Inventor: Reiji Sato, Numazu-shi (JP)

Correspondence Address: PEARNE & GORDON LLP, 1801 EAST 9TH STREET, SUITE 1200, CLEVELAND, OH, 44114-3108, US

(73) Assignees: Kokusan Denki Co., Ltd., Numazu-shi (JP); Honda Motor Co., Ltd., Minato-ku (JP)

(21) Appl. No.: 11/589,647

(22) Filed: Oct. 30, 2006

(30) Foreign Application Priority Data
Nov. 2, 2005 (JP) 2005-319925

(51) Int. Cl. H02K 7/00; H02K 5/10; H02K 21/12

(52) U.S. Cl. 310/156.28; 310/156.26; 310/261; 310/67 R; 310/88

(57) ABSTRACT

A flywheel magnet rotor comprising: a flywheel having a peripheral wall portion and a bottom wall portion formed with a boss in a center thereof, and formed with vent holes passing through the bottom wall portion in an area surrounding the boss in the bottom wall portion; a permanent magnet or magnets secured to an inner periphery of the peripheral wall portion of the flywheel; and a magnet protecting cover that comprises an annular outer flange at one axial end and an annular inner flange at the other axial end and covers the permanent magnet or magnets inside the flywheel, an annular water shutoff ridge surrounding the boss outside the area formed with the vent holes are provided inside the bottom wall portion of the flywheel, the magnet protecting cover is placed so that the outer flange covers an axial end surface of the magnet or magnets on a side of an opening of the flywheel and the inner flange surrounds the water shutoff ridge from outside.

### TECHNICAL FIELD OF THE INVENTION

The present invention relates to a flywheel magnet rotor used as a rotor of a magneto generator driven by a motor such as an internal combustion engine.

### BACKGROUND OF THE INVENTION

A flywheel magnet rotor used as a rotor of a magneto generator comprises a cup-shaped flywheel having a peripheral wall portion and a bottom wall portion, and a plurality of arcuate permanent magnets or a single ring-shaped permanent magnet secured by an adhesive to an inner periphery of the peripheral wall portion of the flywheel, and a boss provided in a center of the bottom wall portion of the flywheel is connected to a rotating shaft of a motor. The plurality of arcuate permanent magnets or the single ring-shaped permanent magnet bonded to the inner periphery of the peripheral wall portion of the flywheel are magnetized so that south poles and north poles are alternately arranged circumferentially of the flywheel, and the permanent magnet forms a field having a predetermined number of poles inside the flywheel.

As the permanent magnet, a sintered magnet such as a ferrite magnet or a rare-earth magnet is used. The sintered magnet is fragile and apts to break, and thus as disclosed in Japanese Patent Application Laid-Open Publication No. 1-99448, an annular magnet protecting cover that covers a permanent magnet is mounted inside a peripheral wall portion of a flywheel.

FIG. 7 is a sectional view of a half of a conventional flywheel magnet rotor using a rare-earth magnet as a permanent magnet. In FIG. 7, a reference numeral 1 denotes an iron flywheel having a peripheral wall portion 1a and a bottom wall portion 1b, and a boss 1c is integrally formed in a center of the bottom wall portion 1b. The peripheral wall portion 1a of the flywheel 1 comprises a first peripheral wall portion 1a1 that occupies substantially a half on a side of an opening of the flywheel, and a second peripheral wall portion 1a2 that occupies substantially the remaining half, and a step 1d is formed between the first peripheral wall portion 1a1 and the second peripheral wall portion 1a2. A plurality of vent holes 1f passing through the bottom wall portion 1b are formed in an area surrounding the boss 1c in the bottom wall portion 1b of the flywheel.

A reference numeral 2 denotes a rare-earth magnet mounted to an inner periphery of the first peripheral wall portion 1a1. In this example, a plurality of magnets are provided and each magnet 2 abuts, at one axial end surface 2a, against the step 1d via a spacer 3 of non-ferromagnetic material and positioned in an axial direction of the flywheel.

A reference numeral 4 denotes a magnet protecting cover of non-ferromagnetic material. The magnet protecting cover 4 comprises a cylindrical cover body 401 that is placed concentrically with the peripheral wall portion of the flywheel 1 and covers an inner peripheral surface of the permanent magnets 2, an annular outer flange 402 protruding radially outward from one axial end of the cover body 401 placed on the side of the opening of the flywheel, and an annular inner flange 403 protruding radially inward from the other axial end of the cover body 401. A portion of the cover body 401 close to the inner flange 403 is a slanting portion 404 slanting radially inward of the flywheel as getting closer to the bottom wall portion 1b.

The outer flange 402 of the magnet protecting cover 4 is formed to have an arcuate section, and placed to cover the other axial end surface of the permanent magnets 2 placed on the side of the opening of the flywheel 1, and the inner flange 403 of the magnet protecting cover 4 abuts against an inner surface of the bottom wall portion of the flywheel.

A seaming portion 1g that holds the outer flange 402 of the magnet protecting cover 4 is formed in an inner peripheral portion of an opening end of the peripheral wall portion 1a of the flywheel, and the seaming portion presses the magnets 2 against the step 1d via the outer flange 402 to secure the magnets 2 to the flywheel 1.

A flywheel magnet rotor FWR′ is comprised of the flywheel 1, the permanent magnets 2, and the magnetic protecting cover 4.

In an example in FIG. 7, a magnetic suction force that acts between the magnets 2 and the peripheral wall portion 1a of the flywheel, and the holding by the seaming portion 1g secure the magnets 2 to the flywheel, but the magnets 2 may be bonded to the peripheral wall portion 1a of the flywheel 1. As shown in FIG. 8, when the magnets 2 is bonded to the inner periphery of the peripheral wall portion of the flywheel, an annular adhesive leak prevention ridge 1e′ that surrounds the boss 1c is formed on the inner surface of the bottom wall portion of the flywheel, and the inner flange 403 of the protecting cover 4 is placed on a top of the ridge 1e′ in order to prevent an excess of adhesive from partly flowing out of the vent holes 1f.

When the permanent magnets 2 are bonded to the inner periphery of the peripheral wall portion of the flywheel, an adhesive having fluidity in an uncured state is permeated and cured between the magnets 2 and the inner periphery of the first peripheral wall portion 1a1 with the opening of the flywheel 1 directed upward. An excess of the adhesive supplied between the peripheral wall portion 1a1 and the magnets 2 flows on the inner peripheral surface of the second peripheral wall portion 1a2 of the flywheel and reaches the inner surface of the bottom wall portion 1b, and is prevented from flowing by the adhesive leak prevention ridge 1e′. Thus, the excess of adhesive 5 is cured between the ridge 1e′ and the second peripheral wall portion 1a2 to prevent the adhesive from flowing toward the vent holes 1f.

Also in this case, a flywheel magnet rotor FWR″ is comprised of the flywheel 1, the permanent magnets 2, and the magnet protecting cover 4. This type of flywheel magnet rotor is disclosed in Japanese Patent Application Laid-Open Publication No. 2000-324779.

When the flywheel magnet rotor is mounted to an engine having a vertical rotating shaft such as an outboard engine, the flywheel magnet rotor is mounted to the engine with the bottom wall portion 1b of the flywheel 1 directed upward and the opening directed downward as shown in FIGS. 7 and 8. When the flywheel 1 is mounted to the motor with the bottom wall portion 1b directed upward, water may enter the flywheel from outside through the vent holes 1f provided in the bottom wall portion 1b of the flywheel.

However, in the conventional flywheel magnet rotor FWR′ in FIG. 7, the inner flange 403 of the magnet protecting cover 4 abuts against the inner surface of the bottom wall portion 1b of the flywheel, and thus part of water W having entered through the vent holes 1f, the part flowing along the inner surface of the bottom wall portion 1b, may enter a space between the protecting cover 4 and the peripheral wall portion 1a of the flywheel through a slight gap between the inner flange 403 of the magnet protecting cover 4 and the bottom wall portion 1b.

Also in the flywheel magnet rotor in FIG. 8, the inner flange 403 of the magnet protecting cover 4 abuts in the axial direction against the top of the ridge 1e′ formed on the inner surface of the bottom wall portion of the flywheel, and thus when water W enters through the vent holes 1f, the water may enter a space between the protecting cover 4 and the peripheral wall portion 1a of the flywheel through a slight gap between the inner flange 403 of the magnet protecting cover 4 and the top of the ridge 1e′.

When the water enters the space between the protecting cover 4 and the peripheral wall portion 1a of the flywheel, the magnets 2 are wet by water, and rust forms on the magnet 2 to degrade performance of the magnet and also reduce adhesive strength of the magnet, which is unpreferable. Particularly, when seawater enters the flywheel in an outboard engine or the like, rust prominently forms on the magnet 2, which increases the problem.

### SUMMARY OF THE INVENTION

An object of the present invention is to provide a flywheel magnet rotor that prevents water having entered a flywheel through vent holes provided in a bottom wall portion of the flywheel from entering a space between a magnet protecting cover and a peripheral wall portion of the flywheel, thereby eliminating the risk of rust forming on a magnet or magnets.

The present invention is applied to a flywheel magnet rotor comprising: a flywheel having a peripheral wall portion and a bottom wall portion that closes one axial end of the peripheral wall portion and provided with a boss for mounting a rotating shaft in a center of the bottom wall portion; a permanent magnet or magnets secured to an inner periphery of the peripheral wall portion of the flywheel; and an annular magnet protecting cover that is mounted inside the peripheral wall portion of the flywheel and covers the permanent magnet or magnets, vent holes passing through the bottom wall portion being formed in an area surrounding the boss in the bottom wall portion of the flywheel.

In the present invention, an annular water shutoff ridge extending continuously circumferentially of the peripheral wall portion is formed inside the bottom wall portion of the flywheel in a position closer to an outer diameter than an area formed with the vent holes. The magnet protecting cover comprises a cylindrical cover body that is placed concentrically with the peripheral wall portion of the flywheel and covers an inner peripheral surface of the permanent magnet or magnets, an annular outer flange protruding radially outward from one axial end of the cover body positioned on a side of an opening of the flywheel, and an annular inner flange protruding radially inward from the other axial end of the cover body, an outer flange of the magnet protecting cover is placed to cover an axial end surface of the permanent magnet or magnets positioned on the side of the opening of the flywheel, and the inner flange of the magnet protecting cover is placed outside the water shutoff ridge in a position closer to the bottom wall portion of the flywheel than a top of the ridge.

As described above, the annular water shutoff ridge extending continuously circumferentially of the peripheral wall portion is provided inside the bottom wall portion of the flywheel in the position closer to the outer diameter than the area formed with the vent holes, the inner flange of the magnet protecting cover is placed outside the annular water shutoff ridge in the position closer to the bottom wall portion of the flywheel than the top of the ridge. Thus, when the flywheel magnet rotor is placed with the bottom wall portion of the flywheel directed upward and the opening directed downward, water having entered from outside through the vent holes provided in the bottom wall portion of the flywheel falls without flowing inside the magnet protecting cover. This prevents water from entering between the magnet protecting cover and the peripheral wall portion of the flywheel to cause the magnet to be wet by water, and prevents rust from forming on the magnet to degrade performance of the magnet or reduce adhesive strength of the magnet.

In a preferred aspect of the present invention, the inner flange of the magnet protecting cover abuts against the inner surface of the bottom wall portion of the flywheel outside the water shutoff ridge.

In another preferred aspect of the present invention, a groove extending continuously circumferentially of the ridge and opening in an opening direction of the flywheel is formed on the top of the water shutoff ridge.

As described above, the groove is provided on the top of the water shutoff ridge to eliminate the risk that water having entered the flywheel through the vent holes flows outside the water shutoff ridge, thereby ensuring prevention of water from entering between the magnet protecting cover and the peripheral wall portion of the flywheel.

In a further preferred aspect of the present invention, an adhesive is placed between the inner flange of the magnet protecting cover and the bottom wall portion of the flywheel to seal between the inner flange and the bottom wall portion of the flywheel with the adhesive.

In a further preferred aspect of the present invention, an adhesive is coated over the inner flange of the magnet protecting cover and the outer peripheral surface of the water shutoff ridge to seal between the inner flange and the outer peripheral surface of the water shutoff ridge with the adhesive.

As described above, the adhesive is placed between the inner flange of the magnet protecting cover and the bottom wall portion of the flywheel to seal between the inner flange of the magnet protecting cover and the bottom wall portion of the flywheel with the adhesive, or the adhesive is coated over the inner flange of the magnet protecting cover and the outer peripheral surface of the water shutoff ridge to seal between the inner flange and the outer peripheral surface of the water shutoff ridge with the adhesive, thereby completely eliminating the risk that water enters between the magnet protecting cover and the peripheral wall portion of the flywheel.

As described above, according to the present invention, the annular water shutoff ridge extending continuously circumferentially of the peripheral wall portion is provided inside the bottom wall portion of the flywheel in the position closer to the outer diameter than the area formed with the vent holes of the bottom wall portion of the flywheel, and the inner flange of the magnet protecting cover is placed outside the annular water shutoff ridge in the position closer to the bottom wall portion of the flywheel than the top of the ridge. Thus, when the flywheel magnet rotor is placed with the bottom wall portion of the flywheel directed upward and the opening directed downward, water having entered from outside through the vent holes provided in the bottom wall portion of the flywheel falls without flowing inside the magnet protecting cover. This prevents water from entering between the magnet protecting cover and the peripheral wall portion of the flywheel to cause the magnet to be wet by water, and prevents rust from forming on the magnet to degrade performance of the magnet or reduce adhesive strength of the magnet.

### BRIEF DESCRIPTION OF THE DRAWINGS

The above and other objects and features of the invention will be apparent from the detailed description of the preferred embodiments of the invention, which is described and illustrated with reference to the accompanying drawings, in which;

FIG. 1 is a bottom view of a flywheel magnet rotor according to a first embodiment of the present invention;

FIG. 2 is a sectional view taken along the line II-II in FIG. 1;

FIG. 3 is an enlarged sectional view of a half of the flywheel magnet rotor according to the first embodiment of the present invention;

FIG. 4 is an enlarged sectional view of a half of a flywheel magnet rotor according to a second embodiment of the present invention;

FIG. 5 is an enlarged sectional view of a half of a flywheel magnet rotor according to a third embodiment of the present invention;

FIG. 6 is an enlarged sectional view of the half of the flywheel magnet rotor according to the third embodiment of the present invention;

FIG. 7 is an enlarged sectional view of a half of a conventional flywheel magnet rotor; and

FIG. 8 is an enlarged sectional view of a half of another conventional flywheel magnet rotor.

### DETAILED DESCRIPTION OF THE PREFERRED EMBODIMENTS

Now, preferred embodiments of the present invention will be described in detail with reference to the drawings.

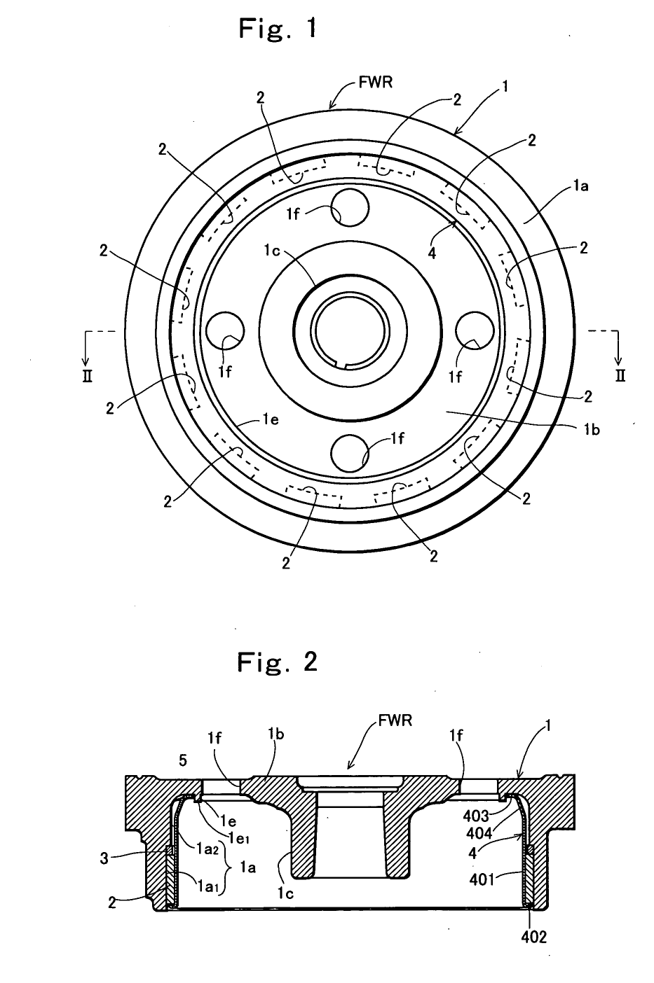

FIGS. 1 to 3 show a first embodiment of the present invention, and in these drawings, 1 denotes a cup-shaped iron flywheel having a peripheral wall portion 1a and a bottom wall portion 1b that closes one axial end of the peripheral wall portion. A boss 1c is integrally formed in a center of the bottom wall portion 1b of the flywheel.

In this embodiment, the boss 1c provided in the center of the bottom wall portion 1b of the flywheel is integrally formed with the bottom wall portion 1b, but a boss provided in a center of a bottom wall portion of a flywheel may be formed separately from the bottom wall portion, and riveted to the bottom wall portion.

The peripheral wall portion 1a of the flywheel 1 comprises a first peripheral wall portion 1a1 that occupies substantially a half on a side of an opening of the flywheel, and a second peripheral wall portion 1a2 that occupies substantially the remaining half, and a step 1d is formed between the first peripheral wall portion 1a1 and the second peripheral wall portion 1a2. Four vent holes 1f passing through the bottom wall portion 1b are formed at equiangular intervals in an area surrounding the boss 1c in the bottom wall portion 1b, and an annular water shutoff ridge 1e protruding from an inner surface of the bottom wall portion 1b and extending continuously circumferentially of the peripheral wall portion 1a is formed integrally with the bottom wall portion 1b in a position closer to an outer diameter than an area formed with the vent holes 1f, 1f, . . . of the bottom wall portion 1b of the flywheel.

The vent holes if are used as inlets for cooling air for cooling an armature placed inside the flywheel, and also as holes through which a tool for stopping rotation of the flywheel is inserted when the boss 1c of the flywheel is fitted to a rotating shaft of a motor (for example, a crankshaft of an engine) to fasten the flywheel to the rotating shaft with a screw member.

A reference numeral 2 denotes a rare-earth magnet formed into an arcuate shape along an inner periphery of the peripheral wall portion of the flywheel 1, and twelve magnets 2 are provided in this embodiment. The magnets 2, 2, . . . are placed at equiangular intervals on the inner periphery of the first peripheral wall portion 1a1. Each magnet 2 abuts, at one axial end surface 2a, against the step 1d via a spacer 3 of non-ferromagnetic material (material other than ferromagnetic material) such as aluminum or stainless steel, and positioned in an axial direction of the flywheel.

The twelve rare-earth magnets 2 are magnetized radially of the flywheel in alternately different magnetizing directions so that north poles and south poles are alternately arranged on the inner periphery of the flywheel, and the magnets form a 12-pole rotation field.

The rare-earth magnet is thin, and thus when the magnet is positioned to directly abut against the step 1d, the amount of leakage flux flowing through the step 1d is increased to reduce an effective amount of magnetic flux that contributes to power generation. Thus, in this embodiment, one axial end surface 2a of each magnet 2 abuts against the step 1d via the spacer 3 of non-ferromagnetic material such as aluminum or stainless steel to position each magnet in the axial direction of the flywheel.

A reference numeral 4 denotes a magnet protecting cover of non-ferromagnetic material. The magnet protecting cover 4 integrally comprises a cylindrical cover body 401 that is placed concentrically with the peripheral wall portion of the flywheel 1 and covers the inner peripheral surface of the permanent magnet or magnets 2, an annular outer flange 402 protruding radially outward from one axial end of the cover body 401 placed on the side of the opening of the flywheel, and an annular inner flange 403 protruding radially inward from the other axial end of the cover body 401. A portion of the cover body 401 close to the inner flange 403 is a slanting portion 404 slanting radially inward of the flywheel as getting closer to the bottom wall portion 1b of the flywheel.

The outer flange 402 of the magnet protecting cover 4 is formed to have an arcuate section, and placed to cover the other axial end surface of the permanent magnet or magnets 2 placed on the side of the opening of the flywheel 1. The inner flange 403 of the magnet protecting cover 4 is formed into a flat shape, and placed outside the water shutoff ridge 1e in a position closer to the bottom wall portion 1b of the flywheel than a top 1e1 of the ridge 1e. In this embodiment, the inner flange 403 of the magnet protecting cover 4 abuts against the inner surface of the bottom wall portion 1b of the flywheel outside the ridge 1e.

When the permanent magnets 2 are bonded to the inner periphery of the peripheral wall portion of the flywheel, the flywheel 1 is placed on a workbench with the opening of the flywheel 1 directed upward, the permanent magnet or magnets 2 is/are placed on the inner periphery of the first peripheral wall portion 1a1 of the flywheel, and an adhesive having fluidity in an uncured state is permeated and cured between the magnet or magnets 2 and the inner periphery of the first peripheral wall portion 1a1. An excess of the adhesive supplied between the peripheral wall portion 1a1 and the magnets 2 flows on the inner peripheral surface of the second peripheral wall portion 1a2 of the flywheel and reaches the inner periphery of the bottom wall portion 1b, and is prevented from flowing by the inner flange 403 of the magnet protecting cover and the water shutoff ridge 1e. Thus, the excess of adhesive 5 is cured between the inner flange 403 of the magnet protecting cover and the second peripheral wall portion 1a2 of the flywheel to prevent the adhesive from flowing toward the vent holes 1f.

In this embodiment, a flywheel magnet rotor FWR is comprised of the flywheel 1, the permanent magnet or magnets 2, and the magnet protecting cover 4.

FIG. 4 is a sectional view of essential portions of a second embodiment of the present invention. In this embodiment, an inner flange 403 of a magnet protecting cover 4 is placed outside a water shutoff ridge 1e in a position closer to a bottom wall portion 1b of a flywheel than a top 1e1 of a ridge 1e and separate from the bottom wall portion 1b.

In order to prevent water having entered through vent holes 1f from entering between the magnet protecting cover 4 and a peripheral wall portion of the flywheel, the inner flange 403 of the magnet protecting cover 4 may be placed outside the water shutoff ridge 1e in the position closer to the bottom wall portion 1b of the flywheel than the top 1e1 of the ridge 1e. Thus, as shown in FIG. 4, the inner flange 403 of the magnet protecting cover 4 may be placed separately from the bottom wall portion 1b of the flywheel without any trouble.

FIG. 5 is a sectional view of essential portions of a third embodiment of the present invention. In this embodiment, a groove 1e2 extending continuously circumferentially of a water shutoff ridge 1e and opening in an opening direction of a flywheel is formed in a top 1e1 of the ridge 1e. Other constructions are the same as in FIGS. 1 to 3, and an inner flange 403 of a magnet protecting cover 4 abuts against an inner surface of a bottom wall portion 1b of the flywheel outside the ridge 1e.

Thus, the groove 1e2 extending continuously circumferentially of the water shutoff ridge 1e and opening in the opening direction of the flywheel is formed on the top 1e1 of the water shutoff ridge 1e to eliminate the risk that water having entered the flywheel 1 through vent holes 1f flows outside the ridge 1e, thereby ensuring prevention of water from entering between the magnet protecting cover 4 and the peripheral wall portion 1a of the flywheel.

In each of the embodiments, an adhesive may be placed between the inner flange 403 of the magnet protecting cover 4 and the bottom wall portion 1b of the flywheel to seal between the inner flange 403 of the magnet protecting cover and the bottom wall portion 1b of the flywheel with the adhesive.

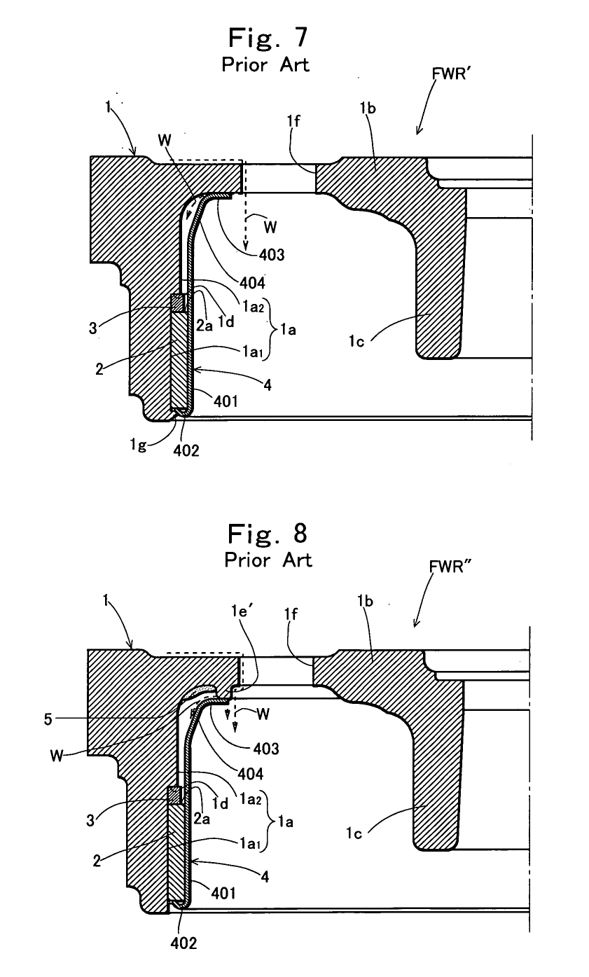

In a conventional magnet rotor in FIGS. 7 and 8, an inner flange 403 of a magnet protecting cover 4 abuts against an inner surface of a bottom wall portion of a flywheel having no ridge, or is placed on a top of a ridge 1e′. Thus, if an adhesive is placed between the inner flange 403 of the magnet protecting cover and a bottom wall portion 1b or between the inner flange 403 and the ridge 1e′, the adhesive inevitably flows out of vent holes 1f. Thus, it is difficult to place the adhesive uniformly between the inner flange 403 of the magnet protecting cover and the bottom wall portion 1b or between the inner flange 403 and the ridge 1e′, and an appropriate seal cannot be provided between the inner flange 403 of the magnet protecting cover and the bottom wall portion 1 of the flywheel or between the inner flange 403 and the ridge 1e.

On the other hand, in the present invention, the inner flange 403 of the magnet protecting cover is placed outside the water shutoff ridge 1e in the position closer to the bottom wall portion 1b of the flywheel than the top 1e1 of the ridge, and thus the ridge 1e prevents the adhesive from flowing toward the vent holes 1f, and the adhesive is placed uniformly between the inner flange of the magnet protecting cover and the bottom wall portion of the flywheel to seal between the inner flange 403 of the magnet protecting cover and the bottom wall portion 1b of the flywheel with the adhesive.

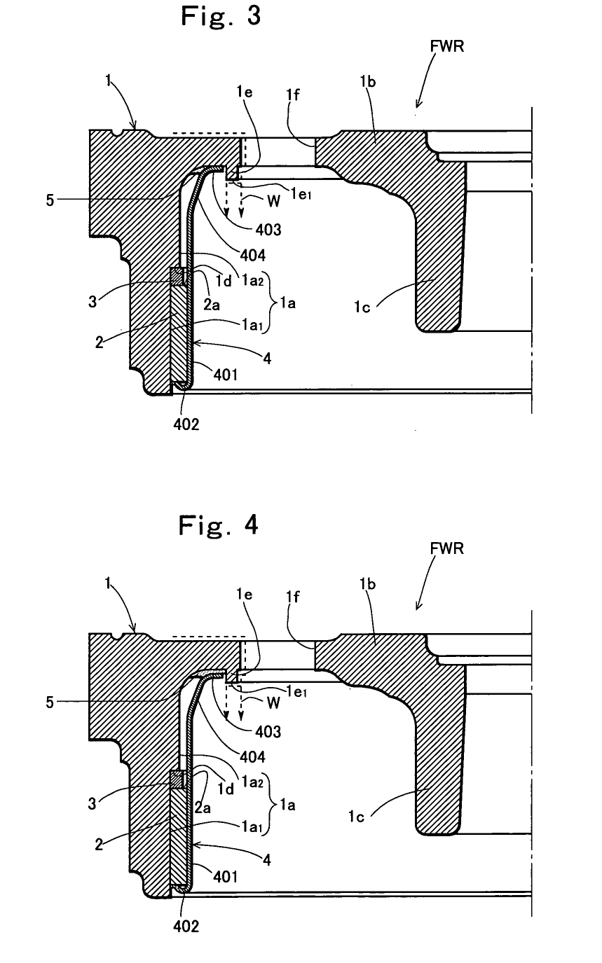

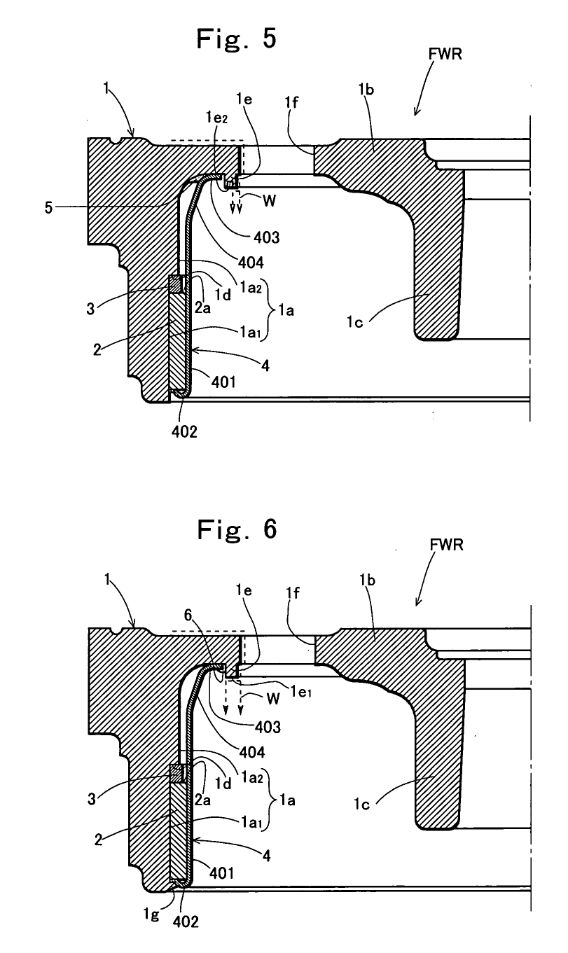

In each of the embodiments, the rare-earth magnets 2 are bonded to the inner periphery of the peripheral wall portion 1a of the flywheel, but a magnetic suction force that acts between the rare-earth magnets 2 and the peripheral wall portion 1a of the flywheel is strong, and the magnets 2 can be mounted to the flywheel without being bonded. FIG. 6 shows an embodiment in which the present invention is applied to a case where magnets are secured to a peripheral wall portion 1a of a flywheel without being bonded. In this example, a seaming portion 1g that holds an outer flange 402 of a magnet protecting cover 4 is formed in an inner peripheral portion of an opening end of the peripheral wall portion 1a of the flywheel 1, and the seaming portion presses the magnets 2 against a step 1d via the outer flange 402 to secure the magnets 2 to the flywheel 1. Other points are the same as in the embodiment in FIG. 3, and an inner flange 403 of the magnet protecting cover 4 is formed into a flat shape and placed outside a water shutoff ridge 1e in a position closer to a bottom wall portion 1b of the flywheel than a top 1e1 of the ridge 1e, and abuts against an inner surface of a bottom wall portion 1b of the flywheel. Also in this example, an adhesive 6 is coated over the inner flange 403 of the magnet protecting cover 4 and an outer peripheral surface of the water shutoff ridge 1e to seal between the inner flange 403 and the outer peripheral surface of the water shutoff ridge 1e with the adhesive 6. The adhesive 6 may be placed between the bottom wall portion 1b of the flywheel and the inner flange 403.

As described above, the adhesive is placed between the inner flange 403 of the magnet protecting cover 4 and the bottom wall portion 1b of the flywheel or between the inner flange 403 of the magnet protecting cover 4 and the outer peripheral portion of the water shutoff ridge 1e to seal between the inner flange of the magnet protecting cover and the bottom wall portion of the flywheel or between the inner flange and the outer peripheral portion of the water shutoff ridge with the adhesive, thereby completely eliminating the risk that water enters between the magnet protecting cover 4 and the peripheral wall portion 1a of the flywheel.

Although a plurality of permanent magnets are secured to the inner periphery of the peripheral wall portion of the flywheel in each embodiment described above, the present invention can be applied to the case where a single ring-like permanent magnet is secured to the inner periphery of the peripheral wall portion of the flywheel.

Although some preferred embodiments of the invention have been described and illustrated with reference to the accompanying drawings, it will be understood by those skilled in the art that they are by way of examples, and that various changes and modifications may be made without departing from the spirit and scope of the invention, which is defined only to the appended claims.

What is claimed is:

1. A flywheel magnet rotor comprising:
a flywheel having a peripheral wall portion and a bottom wall portion that closes one axial end of said peripheral wall portion and provided with a boss for mounting a rotating shaft in a center of said bottom wall portion;
a permanent magnet or magnets secured to an inner periphery of the peripheral wall portion of said flywheel; and
an annular magnet protecting cover that is mounted inside the peripheral wall portion of said flywheel and covers said permanent magnet or magnets,
vent holes passing through the bottom wall portion being formed in an area surrounding said boss in the bottom wall portion of said flywheel,
wherein an annular water shutoff ridge extending continuously circumferentially of said peripheral wall portion is formed inside the bottom wall portion of said flywheel in a position closer to an outer diameter than an area formed with said vent holes,
said magnet protecting cover comprises a cylindrical cover body that is placed concentrically with the peripheral wall portion of said flywheel and covers an inner peripheral surface of said permanent magnet or magnets, an annular outer flange protruding radially outward from one axial end of said cover body positioned on a side of an opening of said flywheel, and an annular inner flange protruding radially inward from the other axial end of said cover body,
said outer flange of the magnet protecting cover is placed to cover an axial end surface of said permanent magnet or magnets positioned on the side of the opening of said flywheel, and
said inner flange of the magnet protecting cover is placed outside said water shutoff ridge in a position closer to the bottom wall portion of said flywheel than a top of said ridge.

2. The flywheel magnet rotor according to claim 1, wherein the inner flange of said magnet protecting cover abuts against the inner surface of the bottom wall portion of said flywheel outside said water shutoff ridge.

3. The flywheel magnet rotor according to claim 1, wherein a groove extending continuously circumferentially of said ridge and opening in an opening direction of said flywheel is formed on the top of said water shutoff ridge.

4. The flywheel magnet rotor according to claim 1, wherein an adhesive is placed between the inner flange of said magnet protecting cover and the bottom wall portion of said flywheel to seal between said inner flange and the bottom wall portion of said flywheel with said adhesive.

5. The flywheel magnet rotor according to claim 1, wherein an adhesive is coated over the inner flange of said magnet protecting cover and the outer peripheral surface of said water shutoff ridge to seal between said inner flange and the outer peripheral surface of said water shutoff ridge with said adhesive.

6. The flywheel magnet rotor according to claim 2, wherein a groove extending continuously circumferentially of said ridge and opening in an opening direction of said flywheel is formed on the top of said water shutoff ridge.
